(19) United States
(12) Patent Application Publication
(10) Pub. No.: US 2015/0056346 A1
(43) Pub. Date: Feb. 26, 2015

(54) Plant-Based Food Products, Compositions, and Methods

(71) Applicant: GOFIT FOODS, LLC, Laguna Hills, CA (US)

(72) Inventor: Geoffrey Margolis, Los Angeles, CA (US)

(21) Appl. No.: 14/533,689

(22) Filed: Nov. 5, 2014

Related U.S. Application Data
(63) Continuation-in-part of application No. 13/428,951, filed on Mar. 23, 2012.
(60) Provisional application No. 61/469,050, filed on Mar. 29, 2011.

(51) Int. Cl. A23J 3/22; A23J 3/14

(52) U.S. Cl. CPC A23J 3/227; A23J 3/14
USPC 426/250; 426/656; 426/657

(57) ABSTRACT

A flavor stabilized hydrated plant protein may be produced by infusing dehydrated plant protein particles with a water solution of flavor(s) and heat denaturable soluble protein(s). A binding and thickening water solution may be added to the flavor stabilized hydrated plant protein to create a formable mass. Fat and/or a fat-oil mixture may be added to the formable mass in the form of molten liquid lipid material to enhance cohesiveness and reduce the saturated-fat content of the formable mass. The formable mass and/or one or more portions thereof may then be cooled and formed into one or more plant-based food products. Prior to forming, the formable mass may be ground so as to enable production of plant-based food products that typically have a smoother texture, such as, e.g., bologna, sausages, meatballs, etc.

### RELATED APPLICATION DATA

This is a continuation-in-part application of U.S. application Ser. No. 13/428,951, filed Mar. 23, 2012, which claims priority from Provisional Application Ser. No. 61/469,050, filed Mar. 29, 2011, all of which are incorporated herein by reference in their entirety.

### FIELD OF THE INVENTION

Embodiments of the present invention relate generally to plant-based food products and to methods and compositions used in producing same. More particularly, embodiments of the invention relate to methods for producing flavor stabilized hydrated vegetable/plant proteins, to compositions of heat denaturable soluble proteins and insoluble food protein(s) and/or gum(s) for use as a binding/thickening agent, to methods of optimizing the amount of water used to produce a plant-based food product of desired texture, to methods of producing a plant-based food product by using a combination of one or more of the aforementioned methods and/or compositions, to methods for adjusting the saturated fat content and/or textures of plant-based food products, and to the plant-based food products thus produced.

### BACKGROUND

It has been well established that both composition (particularly with respect to fat, protein, carbohydrates, and salt) and quantity of food eaten daily can have a significant impact on the health of consumers. More people in the United States die from heart disease than from any other medical condition, and a primary contributor to heart disease is the consumption of foods containing high levels of saturated fat. Equally, obesity resulting from over-indulgence of food and lack of exercise is becoming endemic in the United States and other wealthy nations, and is leading to significant increases in diabetes and hypertension in the general population.

With the so-called “baby boomers” starting to turn 65 years old and their recognition that food can indeed have a significant impact on their health, there is now a strong desire, particularly by this cohort of the population, to modify their diet in a healthier direction.

However, since “eating enjoyment” plays such a powerful role in what a consumer decides to eat, there frequently is a huge difference between the consumer's desire to eat healthy and what is actually eaten. This is largely the result of the fact that most healthier foods unfortunately do not taste as good as their less-healthy alternatives.

The hamburger is the most ubiquitous food product on the American market. Billions of them are sold annually and the vast majority is made from ground meat containing at least 20% fat. Although there are many reasons for the popularity of the hamburger, it is generally agreed that taste, juiciness, and texture are the most important. A great grilled hamburger patty is considered to have the taste and juiciness of grilled beef and a sufficiently solid texture so that the patty remains intact in the sandwich, yet is easy for the consumer to bite through, and the patty piece then easily disintegrates in the mouth after only a few mastications.

The ground beef hamburger patty achieves this unique combination of organoleptic sensations through the inherent properties of meat and the application of meat science.

Prior to forming a raw hamburger patty, meat cuts, frequently containing at least 20% fat, are ground in a meat grinder into various pieces ranging from ⅛ inch to ⅜ inch in size. The ground beef is then formed into patties, either manually for home and single restaurant use, or by high-speed patty-forming machinery that produce hundreds of patties per minute for wide scale distribution.

Forming a meat patty requires that the ground meat be sufficiently sticky to maintain its structure during and after being formed. The fat in the ground meat is normally sufficient to provide this cohesiveness for manually-prepared patties, but forming low fat patties can be difficult. However, when patties are formed on high-speed machinery, it is often necessary to cool the ground beef to a temperature of less than 32° F. to enhance the cohesive structure of the meat being formed into patties, so that the patties can remain intact during the forming process.

When a meat hamburger patty is grilled, the fat melts and various soluble proteins are exuded from the cooking meat. These soluble proteins, which denature at temperatures above 140° F., bind the cooked ground meat particles together and trap the molten fat between the meat particles. Thus, the hamburger patty is able to provide the consumer with a unique eating experience—both good and bad: since it is made from meat, it provides substantial protein (good), but also a lot of fat (bad). Its cooked structure is sufficiently integral to remain intact in the hamburger bun, yet readily breaks apart in the mouth during mastication. Further, since the ground meat pieces are of variable size, they provide textural variety in the mouth when the hamburger piece is chewed, and the variable piece sizes also allow space for the molten fat to accumulate and supply juiciness to the eating experience.

On the other hand, plant-based food products (vegetarian or vegan) have the potential to provide consumers with the healthy alternatives that they are seeking. Plant-based foods are generally lower in fat, high in fiber, and can provide as much protein as meat-based products. Further, since plants require substantially less feed and energy for their nourishment, as compared to animals, plant-based foods are certainly derived from environmentally friendly raw materials.

Most plant-based food products attempt to mimic similar meat-based products and claim to provide a similar eating experience. However, this is not the case, and, although most plant-based burgers, meatballs, and other food products provide consumers with healthier alternatives to their meat-based equivalent products, they are deficient in flavor, texture, and eating enjoyment.

Plant-based burgers attempt to simulate the meat pieces of a regular hamburger by using either small vegetable pieces or pieces of “texturized vegetable proteins” (TVP) in their formulation. Those plant-based burgers made largely from vegetable/cereal pieces such as rice, onions, mushrooms, oats, etc. contain less fat than regular meat hamburgers, but unfortunately are lacking in protein. However, their largest deficiency is in eating quality—they are soft and “mushy” in texture and lacking in meat flavor.

However, the majority of plant-based burgers use TVP particles (frequently made from soy) to provide both protein and improved texture to the product. Although the texturized vegetable protein particles can overcome the “mushy” texture of purely vegetable-based burgers, they still suffer from significant eating quality defects relative to a meat hamburger. Thus, currently-available commercial products have been found to have either too hard or too soft a texture, and there is a lack of piece size variety during mastication in the mouth. In addition, many of these commercial products lack authentic meat-like flavors. Also, frequently, after a few mastications, an unpleasant soy taste emerges indicating leaching of added meat-like flavors from the texturized vegetable protein particles' surface or interior.

Many of the commercially available plant-based burger eating-quality deficiencies can be attributed to how they are made. Manufacturers have been only partially successful in using vegetable pieces and/or texturized vegetable proteins to simulate the texture of a meat hamburger. Since these plant-derived pieces are not normally sticky like ground meat, various formulations have been used to provide binding cohesiveness to the pieces so that a patty can be formed and maintain its integrity through the manufacturing and grilling steps.

Generally, plant-based patties are manufactured by first placing defined quantities of vegetable pieces or texturized vegetable protein pieces in a mixing vessel together with meat-like flavors, spices, and, to provide binding to the pieces, insoluble protein powders (such as gluten or isolated soy protein) and/or gums, starches, and sometimes egg white powders. Water (frequently representing at least 60% of the formulation) is then added to the mixture in the mixing vessel, and the entire mass is mixed for a defined period. The meat-like flavors dissolve in the water and the flavored water is absorbed into or adsorbed onto, the surface of the vegetable pieces or texturized vegetable protein. Water is further absorbed into the binding compounds so as to form a sticky mass that should hold together the vegetable pieces or texturized vegetable proteins during patty forming.

This method of manufacturing, where all the ingredients are simultaneously mixed together, has the advantage of simplicity. However, it has drawbacks regarding the flavor and texture of the plant-based patty that is produced. In particular, many of the insoluble protein powders, gums, and even finely powdered flavors do not easily dissolve in water. On the other hand, dry TVP rapidly absorbs water. As a consequence, the amount of flavors absorbed into the TVP can be reduced and variable, and the binding power of the liquid mass surrounding the hydrated pieces can also be quite variable. Frequently, this then results in the cooked patty having either a gummy or a too-firm texture. Similarly, the texture of currently-available plant-based meatballs, sausage links, and other such products is frequently quite crumbly and does not match the firmer, less particulate, but more cohesive structure of equivalent products made with meat.

Clearly plant-based burgers are not as acceptable to the consumer as meat-based hamburgers, as evidenced by the sales of plant-based burgers that still remain only a very small fraction of total hamburger sales. There is therefore a need for substantially improved plant-based burgers and other plant-based products that can provide major health benefits and improved eating quality and enjoyment for consumers.

### SUMMARY

Methods are provided herein for preparing plant-based burgers with excellent nutritional characteristics that closely resemble the taste and texture of a meat hamburger. In one aspect, methods are described for preparing a plant-based burger containing similar quantities of protein but substantially less fat than a regular meat hamburger. In another aspect, methods are described for hydrating dry TVP particles with a water-based mixture of flavors and a heat denaturable soluble food protein so as to infuse and stabilize the flavors within the TVP particles.

In yet another aspect, methods are described for binding the flavor stabilized TVP particles together so that patties can be formed at high speeds on patty-forming equipment. In a further aspect, methods are described for binding the flavor-stabilized TVP particles so that upon grilling the formed patty, the cooked patty closely resembles the flavor, color, texture, and eating characteristics of a grilled meat hamburger.

Low-fat plant-based patty products are disclosed that closely resemble the flavor, color, texture, and eating characteristics of a grilled meat hamburger through the use of variable sized flavor-stabilized TVP particles, and concentrated solutions of heat denaturable soluble proteins, insoluble proteins, and heat thickening gums.

Thus, in one embodiment, a method for producing a flavor-stabilized hydrated texturized plant protein includes infusing dehydrated texturized plant protein particles with a water solution including both flavors and heat-denaturable soluble proteins.

In another embodiment, a method for producing a plant-based patty product includes hydrating dry texturized plant protein particles of variable sizes with a defined quantity of water solution of flavors and heat-denaturable soluble proteins, binding the dehydrated texturized plant protein particles together with a binding and thickening water solution to create a formable mass which may then be cooled, and forming the formable mass into patty shapes.

In yet another embodiment, a method for controlling and minimizing the amount of water needed to make a plant-based patty of desired texture includes separately hydrating texturized plant protein particles with a defined and limited quantity of water, preparing a concentrated binding and thickening solution by dissolving and hydrating binding and thickening agents in a minimum amount of water necessary to make the binding and thickening solution usable for binding the hydrated texturized plant protein particles into a formable mass, and forming the formable mass into patty shapes.

In another embodiment, a composition for a binding system to be used in binding hydrated texturized plant proteins into a formable mass includes heat-denaturable soluble proteins, one or more of insoluble food proteins and gums, and the minimal amount of water necessary to solubilize the heat-denaturable soluble proteins.

In other aspects of the invention, methods are presented for reducing the amount of saturated fat in plant-based products. In addition, alternative simpler ways are described for incorporation of fat and oils into plant-based products while still maintaining their desired texture. Thus, in one embodiment, a method of producing a plant-based food product includes hydrating dry plant protein particles with a defined quantity of water solution of one or more flavors and one or more heat denaturable soluble proteins to obtain hydrated plant protein particles, adding a binding and thickening water solution to the hydrated plant protein particles so as to create a formable mass, adding fat material to the formable mass, and, after the addition of fat, forming the formable mass or one or more portions thereof into a food product. In embodiments, the fat material may be first melted into liquid fat prior to addition to the formable mass. In some embodiments, the fat material may be a mixture of fat and liquid oil, which may also be melted prior to addition to the formable mass.

Embodiments of the invention are also directed to methods for producing finely structured, more cohesive textures in plant-based products that mimic the textures of meatballs, sausages, and other such products. Thus, in yet another embodiment of the invention, a method for producing a plant-based food product includes hydrating dry plant protein particles with a defined quantity of water solution of one or more flavors and one or more heat denaturable soluble proteins to obtain hydrated plant protein particles, adding a binding and thickening water solution to the hydrated plant protein particles so as to create a formable mass, grinding the formable mass to produce a ground formable mass, and forming the ground formable mass or one or more portions thereof into a food product. In embodiments, fat (including a fat-oil mixture) may also be added to the formable mass just prior to grinding. In addition, the dry plant protein particles may comprise texturized and/or non-texturized plant protein particles. In a preferred embodiment, the dry plant protein particles are not ground while dry (i.e., pre-hydration, pre-addition of the binding and thickening water solution, and/or pre-addition of fat material).

### BRIEF DESCRIPTION OF THE DRAWINGS

FIG. 1 is a flow diagram showing steps, components, and compositions in accordance with embodiments of the invention.

FIG. 2 is a flow diagram showing steps, components, and compositions in accordance with embodiments of the invention.

FIG. 3 is a flow diagram showing steps, components, and compositions in accordance with embodiments of the invention.

FIG. 4 is a flow diagram showing steps, components, and compositions in accordance with embodiments of the invention.

FIG. 5 is a table of formulations used to prepare products made with liquid egg white and without liquid egg white in accordance with embodiments of the invention.

FIG. 6 is a table of formulations used to prepare products in accordance with embodiments of the invention.

FIG. 7 is a table of formulations used to prepare products in accordance with embodiments of the invention.

FIG. 8 is a table listing the saturated fat content of six (6) alternative fats and fat-oil mixtures.

FIG. 9 is a table of formulations used to prepare burgers in accordance with embodiments of the invention.

FIG. 10 is a table of formulations used to prepare meatballs in accordance with embodiments of the invention.

FIG. 11 is a table of formulations used to prepare products having finer, less particulate, and less crumbly textures in accordance with embodiments of the invention.

### DETAILED DESCRIPTION

Methods are described for preparing a plant-based burger that, upon consumption, closely resembles the taste, texture, and color of a regular grilled meat hamburger, yet is healthier for the consumer to eat.

The plant-based burgers described herein are made from texturized plant proteins, which are a good source of protein. In addition, the texturized plant proteins, which are supplied as dehydrated particles, are available in different sizes and shapes. Thus, according to one embodiment of the present invention, TVP particles of various sizes, shapes, and speed of water-absorption are used to make the plant-based burger. These different types of TVP provide the textural variety to the patty, thus simulating the various meat piece sizes in a meat hamburger.

In order to resemble the taste of a regular grilled meat hamburger, it is essential to both mask the inherent soy flavor of the TVP particles used in preparing the plant-based burger, and to also provide an authentic meat-like flavor to the TVP pieces. Further, it is important that this meat-like flavor not readily leach out of the TVP during mastication thus returning the inherent soy flavor of the TVP.

According to one embodiment of the invention, dry TVP pieces of various sizes, shapes, and speed of water-uptake are hydrated by a water solution containing meat-like flavor and heat denaturable soluble food proteins. The TVP pieces and the water solution are mixed until the entire water solution has been absorbed by the TVP. Typically, a ratio of around 2.6/1 water to TVP is used, but other ratios will also work. The meat-like flavors are generally reaction-type flavors produced by Maillard reactions; and heat denaturable soluble food proteins such as egg white (albumen), whey proteins, fractionated soy proteins, etc. can be used, provided that the proteins denature and solidify in a temperature range from about 120° F. to about 180° F.

Hydrating the TVP in this manner guarantees that the flavor to TVP ratio is well defined. In addition, as the patty is being grilled (cooked) and its internal temperature rises above 150° F. (which is required for food safety reasons), the heat denaturable proteins within the TVP solidify, sealing the flavor components within the hydrated TVP particles. In this manner, when the plant-based patty is eaten, the meat-like flavors are uniform during the entire time that the patty is being chewed in the consumer's mouth, since the flavors cannot easily be leached out of the TVP by saliva. As such, the inherent and unacceptable soy flavor of the TVP is essentially masked.

Clearly, these flavor-stabilized TVP particles can also be used for other plant-based food product alternatives to meat products. For example, they can be used in chilis, soups, pizza toppings, sauces, or any food product that normally would contain small pieces of meat.

Equally, ingredients that are non-texturized, but generally solid (e.g., powders), such as plant-based proteins, concentrates, isolates, starches, and the like can also be hydrated by a water solution containing various flavors and heat denaturable soluble food proteins. Such non-texturized flavor stabilized materials are particularly useful in developing and producing plant-based food products that typically have a smoother texture, such as, e.g., bologna, sausages, and similar types of products.

Other embodiments are directed to methods for replicating the structure and texture of meat hamburgers, breakfast sausage patties, meatballs, and other ground meat products in plant-based food products. Surprisingly, it has been discovered that this can be achieved by a combination of processing and formulation changes.

Although the above-described flavor-stabilized hydrated TVPs provide piece textural variety, these pieces have to be bound together so that patties, meatballs, and other shaped products, e.g., can be formed and maintain their structure throughout cooking or grilling. However, for eating enjoyment, the cooked products need to also be sufficiently friable that upon entering the consumer's mouth the products can disintegrate within a few mastications. It has been discovered that with water management and the use of heat denaturable soluble foods proteins and binding agents it is possible to achieve this desired texture.

However, certain non-hamburger products, such as meatballs and sausages, have little piece textural variety, but instead provide the consumer with a finer, smoother, and non-crumbly particulate texture when eaten. Here, using dry TVP flakes and/or particles in accordance with specific embodiments of the invention provides a more crumbly product that may not mimic the eating texture of its equivalent meat products as closely as may be desired. In this regard, reducing the particulate size of the dry TVP by grinding prior to hydration certainly results in a smoother, less crumbly product, but with more grittiness when eaten.

Surprisingly, it has been discovered that the desired finer, smoother, non-crumbly, and non-gritty particulate texture can be achieved by simply using various flakes and particulate dry TVPs in the product formulation, and then grinding the entire cooled hydrated plant protein formable mass prior to forming. This will be explored in further detail hereinafter.

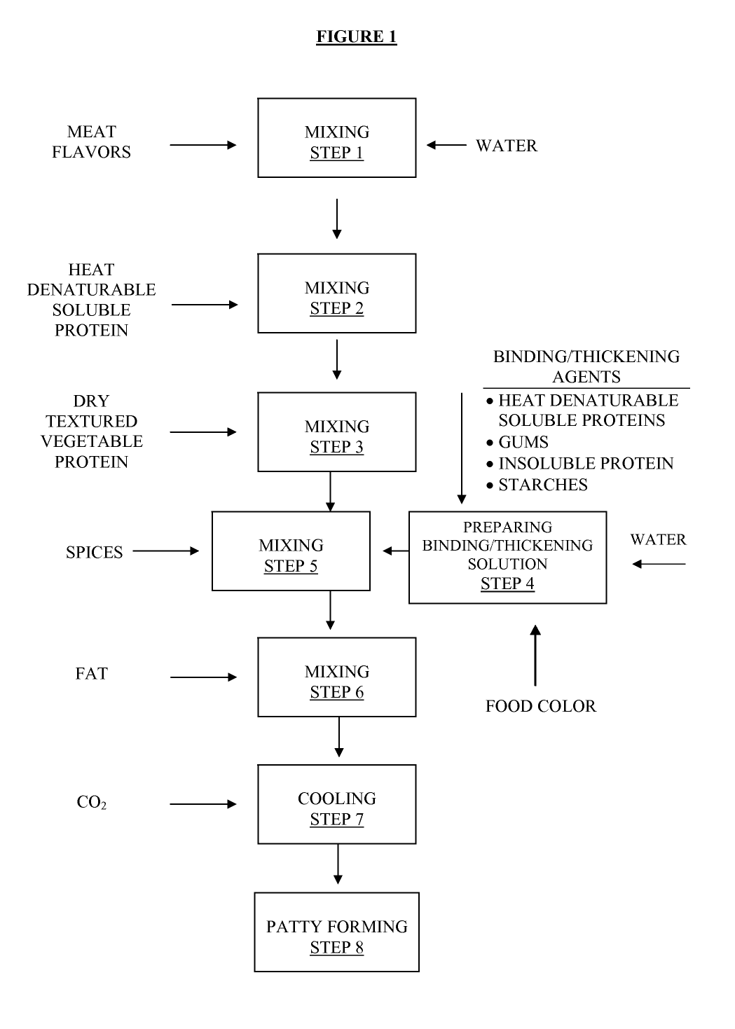

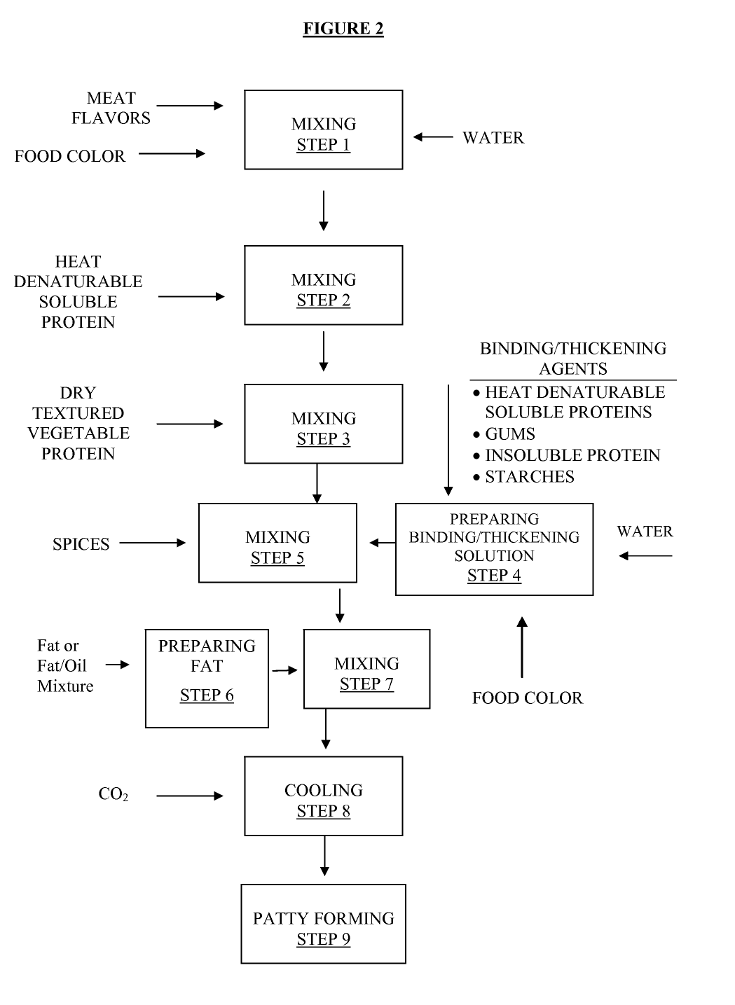

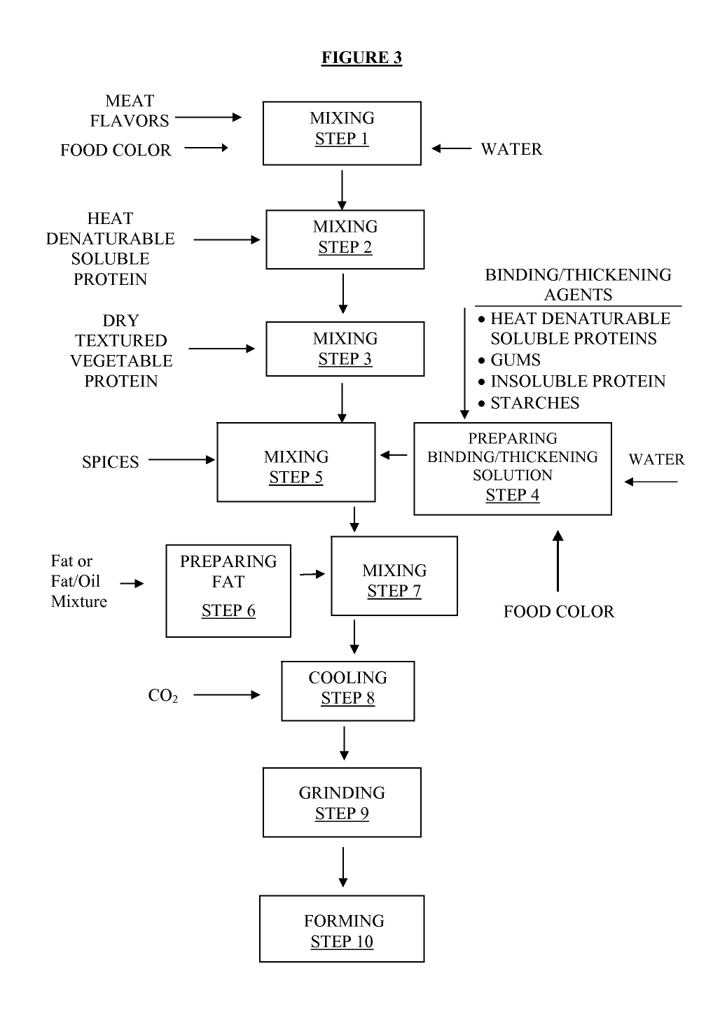

Returning to plant-based patties, an embodiment of the invention is shown in FIG. 1. As indicated, the methodology requires a sequence of well-defined steps designed to stabilize meat flavors in texturized plant proteins, and to create desired product textures by careful water management and the use of heat dependent binding and thickening agents. As will be described in more detail hereinbelow, it is important to note that FIG. 1, as well as FIGS. 2 and 3, reflect only the use of “dry texturized vegetable protein”. However, non-texturized plant proteins may also be used, either in addition to, and/or in place of, texturized plant proteins.

In Step 1 of FIG. 1, defined quantities of meat flavors are dissolved in a defined quantity of water. A defined quantity of heat denaturable soluble proteins such as “liquid egg white” is then mixed into the meat flavor solution (Step 2). Alternatively, the defined quantities of meat flavors and heat denaturable soluble proteins can be simultaneously dissolved in a defined quantity of water. The combined liquid mixture is added to a pre-weighed quantity of dry texturized vegetable protein placed in a mixing vessel. The TVP and added liquid mixture are mixed for about 40 minutes, by which time all the flavored/protein liquid mixture has been substantially all absorbed by the TVP (Step 3).

During the period while the TVP is being hydrated, the binding/thickening solution is prepared by completely dissolving and hydrating the binding/thickening agents together with any food grade colorants into a defined quantity of water (Step 4). Once the TVP is hydrated, spices are first mixed with the hydrated TVP, and then the binding/thickening solution is added to the hydrated TVP and the mixture is mixed for about 4 minutes (Step 5) to produce a thick moist but semi-solid mass. Fat (preferably solid small pieces at room temperature to provide for uniform distribution throughout the moist semi-solid mass) is then added (Step 6) and mixed in for about 2 minutes.

It is noted that, in one embodiment of the invention, no fat, oil, or other lipid material is introduced into the methodology at all prior to Step 6. As will be discussed in detail below in connection with Examples 9-12 (and variations thereof), it has been found that the addition of lipid material at an earlier stage in the methodology—and, especially, during the hydration process—generates a less-desirable spongy texture, as well as a visibly unattractive cream/brown colored layer, in the plant-protein product, and could prevent production of an optimally flavor stabilized plant-protein product.

Continuing with FIG. 1, surprisingly and unexpectedly, it has been found that the addition of fat at this point in the processing sequence (i.e., Step 6) may cause the TVP/binder/thickener moist mass to become drier and to produce a mass of generally moist crumbly pieces which are generally surrounded by the binder/thickener. The combined semi-solid mass and fat pieces are then cooled with dry ice (solid carbon dioxide) to a temperature of between about 27° F. and about 29° F. (depending on formulation) (Step 7). The cooling stiffens the mass of the moist crumbly pieces so that they can be easily formed in high-speed forming machinery. Once formed (Step 8), the food product may then be frozen for subsequent cooking (grilling), or immediately cooked and then frozen. In the latter situation, the cooked and frozen product would need to be reheated prior to consumption.

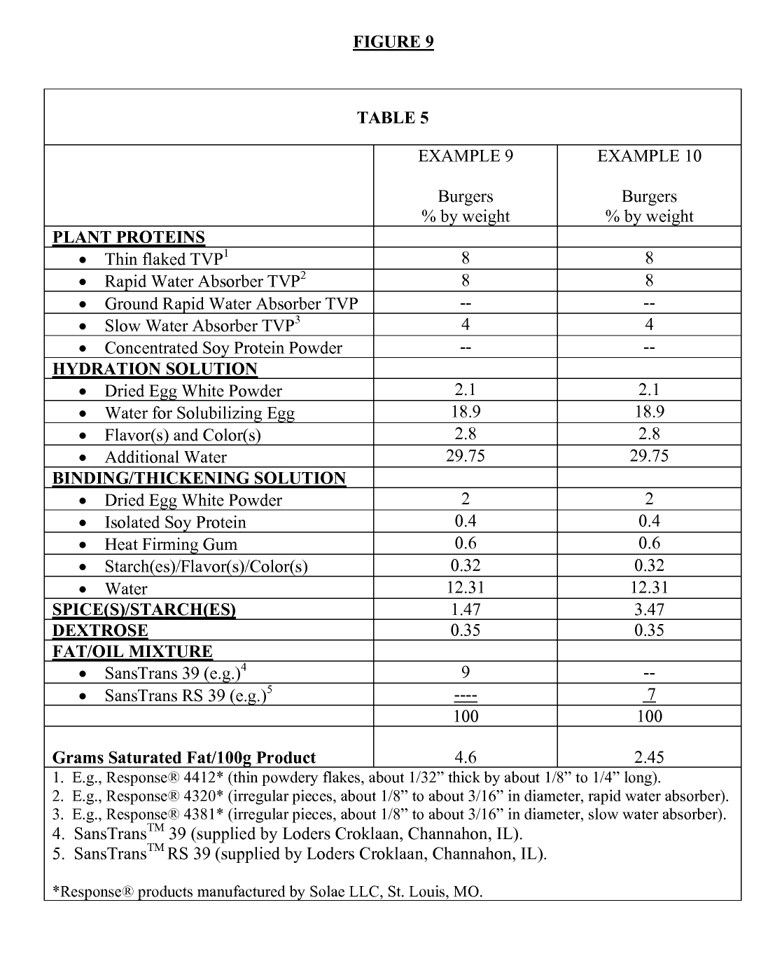

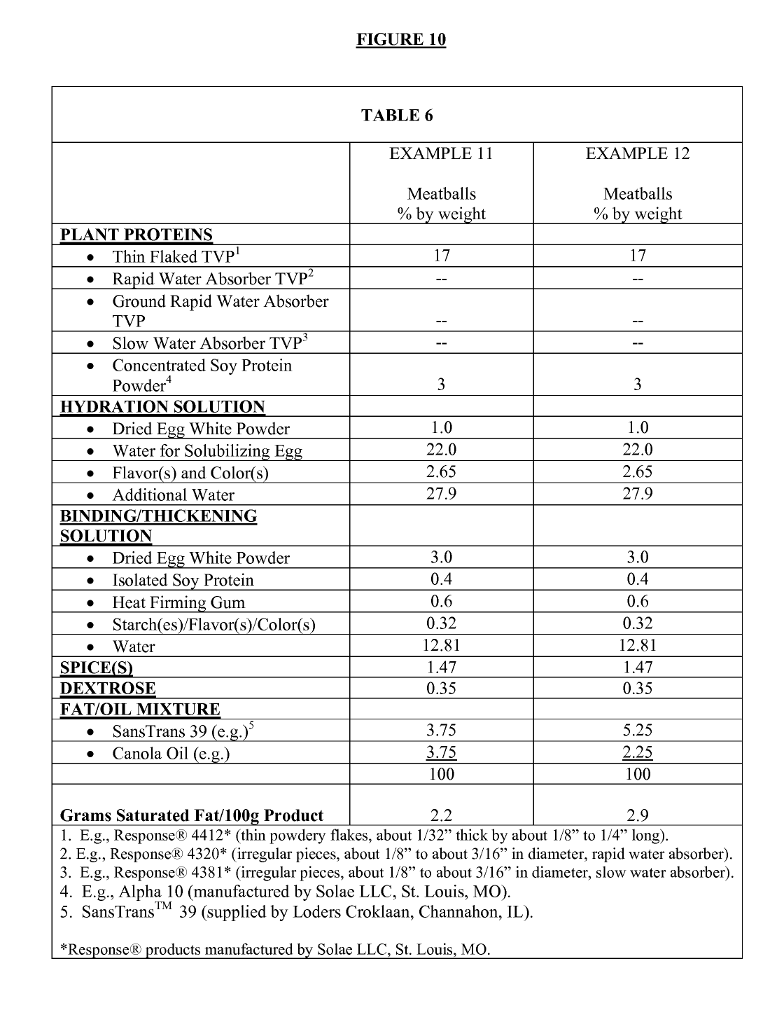

Embodiments of the invention may entail certain variations to aspects of specific steps that are set forth in FIG. 1. For example, depending on the color of the TVP (and/or non-texturized plant proteins) used (Step 3), colorants can be added to the hydrating solution—e.g., in addition to being added in Step 4—to assist in appropriately adjusting the product color. Also, as a variant to the above-described embodiment, portions of the mass of moist crumbly pieces produced in Step 6 of FIG. 1 can also be used to form plant-based “meat balls,” “meat loaf,” lasagna, sausages, or any other food product that would normally be made with ground meat. This and other methodologies relating to meatballs and similar ground-meat-like food products are explored further hereinbelow in connection with FIGS. 9 and 10.

In a further embodiment of the invention, it has been discovered that the hydrated binding/thickening agents used in Steps 4 and 5 (FIG. 1) also provide juiciness to the plant-based burger when consumed. As a consequence, in embodiments of the invention, it is only necessary to add between ⅓ and ½ the amount of fat (Step 6) as compared to a 20% fat meat hamburger, e.g., when manufacturing the plant-based burger. This is a significant nutritional advantage.

Nutritionists recommend that consumers should reduce not only their total fat intake, but also the proportion of saturated fat in the fat/oil they consume. However, saturated fats (such as tallow or lard associated with beef or pork) greatly enhance the eating enjoyment and juiciness of meat-based products, and provide necessary cohesiveness to assist in the formation of casing-less food products, such as, e.g., hamburgers and meatballs.

It is known that replacement of high saturated fats with various vegetable liquid oils such as canola oil (7% saturated fat) and soya bean oil (14% saturated fat) would result in a reduction in the saturated fat levels of the plant-based products. Unfortunately, however, the liquid oil would also make it impossible to form casing-less products—such as hamburgers, breakfast sausage patties, and meatballs—as the liquid oil would make the plant-based mass too “liquidy”, or moist, to (retain a) form.

In this regard, in accordance with an embodiment of the invention, it has been discovered that it is possible to use a mixture of a saturated fat and a liquid oil to produce such casing-less plant-based food products, provided that the fat-oil mixture solidifies at a temperature greater than about 40-50° F. In this way, the saturated fat level in the lipid mixture used to make the plant-based product can be substantially reduced by the replacement of a portion of the fat by liquid vegetable oil, yet the lipid mixture can still provide cohesive assistance in product forming by solidifying at a temperature above the temperature to which the plant-protein mass needs to be cooled prior to forming (i.e., between about 27° F. and about 29° F.).

Another embodiment of the invention is shown in FIG. 2. As indicated earlier, the methodology requires a sequence of well-defined steps designed to stabilize meat flavors in texturized and non-texturized plant proteins and to create desired product textures by careful water management and the use of heat dependent binding and thickening agents.

FIG. 2 is directed to an alternative—and simpler—method for the addition of fat or fat-oil mixtures during the manufacture of plant-based products. This method is particularly useful for the addition of liquid fat-oil mixtures that are necessary to reduce the saturated fat content of fats that are solid at room temperature. Specifically, the methodology of FIG. 2 entails generally the same first 5 steps as those of the methodology of FIG. 1, including, optionally, the addition of colorant(s) to the hydration solution used in Step 1. After Step 5, however, instead of adding the fat as small solid particulate pieces (see Step 6 in FIG. 1), the methodology of FIG. 2 calls for first melting the fat or fat-oil mixture in a fat-preparation step (Step 6), and then adding the molten lipids as a liquid by spraying or frequent manual additions to the thick semi-solid mass (Step 7). Preferably, the temperature of the liquid fat or fat-oil mixture is between about 100° F. to about 120° F. such that, upon contacting the cold thick semi-solid mass, the liquid lipids start to congeal and solidify since the thick semi-solid mass typically has a temperature of about 50° F. (i.e., the standard environmental temperature found in meat processing facilities).

In a preferred embodiment, the liquid lipids are added to the thick semi-solid mass over a period of approximately 2-5 minutes with continued mixing (Step 7), and then the entire combined mass is cooled with dry ice (solid carbon dioxide) to a temperature of between about 27° F. and about 29° F. (depending on formulation) (Step 8). In this way, the cooling and well-distributed solidified lipids further stiffen the thick semi-solid mass so that lower saturated fat products can also easily be formed into various casing-less shapes such as hamburgers and breakfast sausage patties in high speed forming machines typically used in industrial, high-throughput settings. It is noted that, in an alternative embodiment, the cooled thick semi-solid mass can also be stuffed into casings to form products such as sausages and hot dogs.

FIG. 3 shows a methodology in accordance with a further embodiment of the invention. It has been discovered that it is possible to make plant-based products (e.g., meatballs) that require a finer, firmer, less particulate, and less crumbly texture by grinding texturized plant-protein ingredients after they have been hydrated, rather than reducing their size by grinding them in the dry state prior to hydration.

Referring to FIG. 3, the methodology described therein requires, as in FIGS. 1 and 2, a sequence of well-defined steps designed to stabilize meat flavors in texturized and non-texturized plant proteins and to create desired product textures by careful water management and the use of heat dependent binding and thickening agents. More specifically, the steps of the methodology described in FIG. 3 are similar to those of the methodology described in FIG. 2, except that, after the liquid lipid material has been added and thoroughly mixed with the thick semi-solid mass (see Step 7), the entire mixture is cooled (Step 8) to a temperature of between about 27° F. and about 29° F. (depending on formulation), and then passed through a grinder with grinder plate holes of ⅛ inch (or 3 mm) in diameter. This grinding step (Step 9) serves to reduce and produce uniform-sized, not-gritty plant-protein pieces. However, different textures can be produced by adjusting the grinder plate hole diameter, such that smaller holes produce finer texture, and larger holes produce coarser texture.

After grinding, the mixture is formed (Step 10) into various casing-less shapes, such as meatballs, in high-speed forming machines. Alternatively, the finer ground thick semi-solid mass can also be stuffed into casings to form products like sausages and hot dogs.

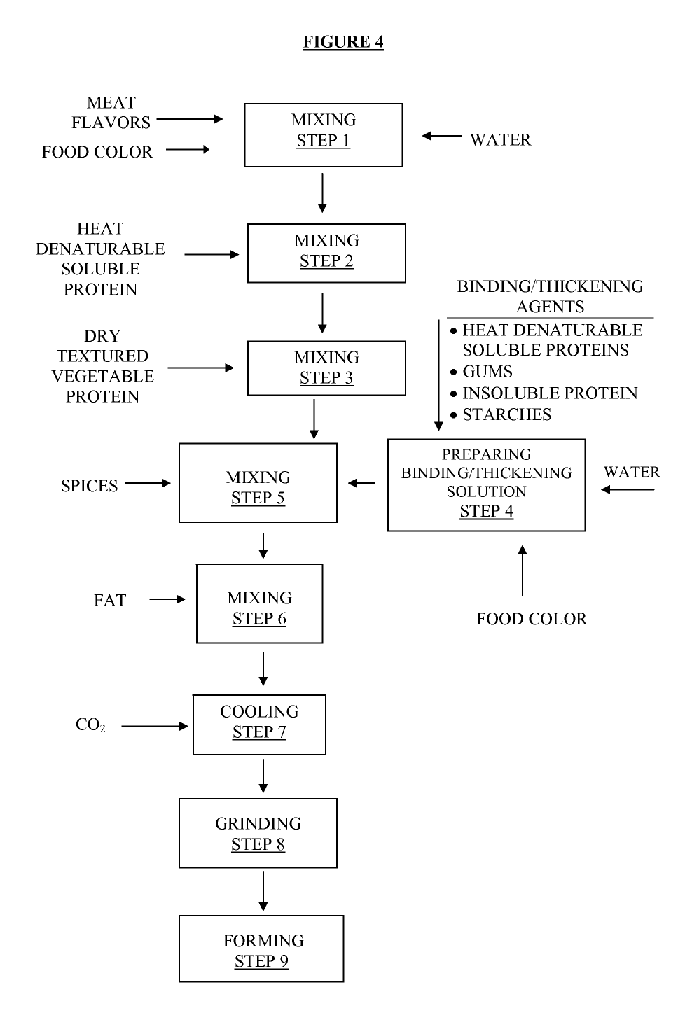

It is noted that, although the methodology of FIG. 3 is described vis-à-vis FIG. 2—i.e., wherein a fat or fat-oil mixture in molten liquid form may be added prior to the cooling and grinding steps—such addition of molten fat (or fat-oil mixture) is not required for production of plant-based products having a finer, firmer, less particulate, and less crumbly texture (e.g., meatballs) in accordance with embodiments of the present invention. In this regard, FIG. 4 shows a methodology vis-à-vis FIG. 1. Here, as before, the methodology entails a sequence of well-defined steps designed to stabilize meat flavors in texturized and non-texturized plant proteins and to create desired product textures by careful water management and the use of heat dependent binding and thickening agents. Thus, the methodology of FIG. 4 includes generally the same first 6 steps as those of the methodology of FIG. 1, including, optionally, the addition of colorant(s) to the hydration solution used in Step 1.

After Step 6, however, the entire mixture is first cooled (Step 7) to a temperature of between about 27° F. and about 29° F. (depending on formulation), then passed through a grinder (e.g., with grinder plate holes of ⅛ inch (or 3 mm) in diameter), which serves to reduce and produce uniform-sized, not-gritty plant-protein pieces (Step 8 of FIG. 4). The entire semi-solid mass is then formed (Step 9) into various casing-less shapes, such as meatballs, in high-speed forming machines. Alternatively, the cooled finer ground thick semi-solid mass can also be stuffed into casings to form products like sausages and hot dogs.

The following specific examples are provided for purposes of illustrating various aspects and embodiments of the invention, and no limitations are intended thereby.

### Examples 1 and 2

Examples 1 and 2 were undertaken to demonstrate the effectiveness of using heat denaturable food proteins to minimize flavor leaching from hydrated TVP.

Texturized vegetable proteins were hydrated either with water or with a mixture of water and liquid egg white (albumin). In both cases, a blue food grade dye was added to the hydrating solution.

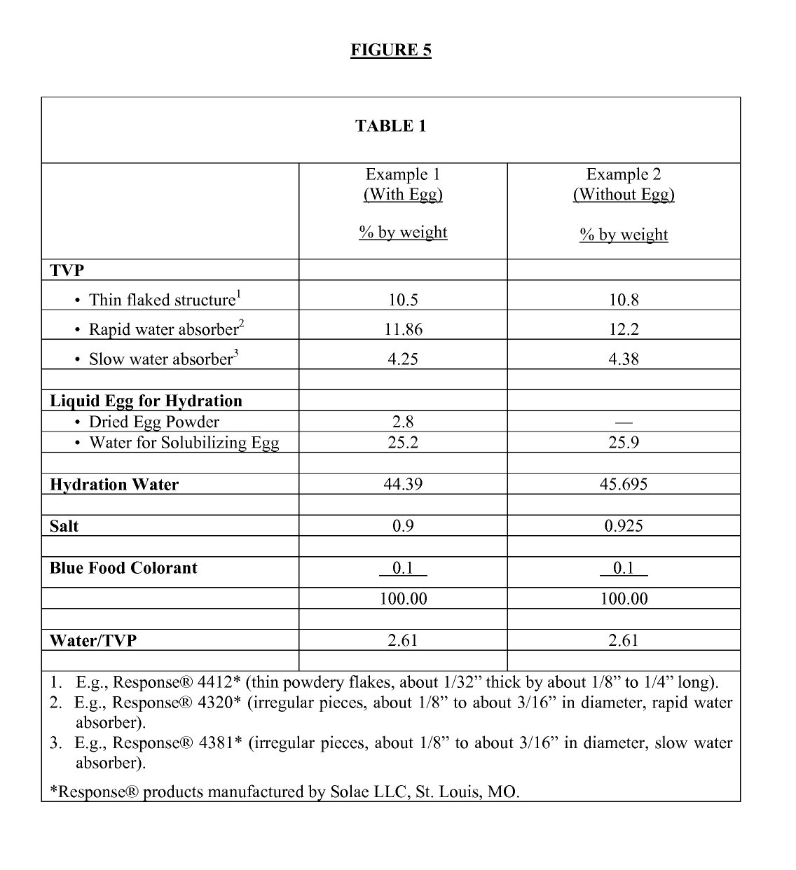

Table 1 in FIG. 5 presents the formulations used to prepare the product made with liquid egg white (Example 1) and without liquid egg white (Example 2). 300 grams of hydrated TVP were prepared for both examples.

The TVP, egg white solution (Example 1) and additional hydration water percentages were chosen to approximate the relative percentages that were used in preparing various complete plant-based burgers (see, e.g., Examples 6 and 8).

In the case of Example 1, a liquid egg white solution was first prepared by slowly dissolving powdered egg white into water using a whisk. The dried egg powder to water ratio of 1/9 was chosen to make a liquid egg solution similar to liquid egg whites obtained directly from eggs. Salt (to simulate flavors), blue food coloring, and additional hydration water were added to the liquid egg white solution according to the formulation presented in Table 1.

A mixture of various TVP products was then weighed and placed in a small plastic container, to which the liquid hydrating solution (containing liquid egg white, salt and blue dye) was added and the solid/liquid was manually mixed every 2-3 minutes until all the liquid had been absorbed by the TVP (approximately 40 minutes).

Hydrated TVP for Example 2 was prepared in a similar fashion, except that no egg white powder was used. However, a similar total water-to-TVP ratio was maintained.

The two hydrated TVP products were allowed to stand for two hours for complete equilibration. Then, 50 grams of each hydrated TVP was placed in two different frying pans, each heated to about 360° F., and the TVP crumbles were continuously mixed for 5½ minutes. This heating time was similar to the time used in grilling the plant-based burgers and served to heat the crumbles to a temperature in excess of 165° F.

At the end of the “grilling” period, approximately 30 grams of each hydrated TVP was placed in about 250 ml of water in two separate glass containers, and each was stirred with a spoon for approximately 2-3 minutes. The water in the glass containing TVP from Example 2 turned a strong blue color. The water in the glass containing TVP from Example 1 remained essentially clear with a very slight blue color.

This confirmed that the addition of heat denaturable food proteins in the meat-flavored liquid used to hydrate TVP will seal the absorbed flavors within the TVP particles.

### Examples 3, 4, and 5

In manufacturing plant-based burgers, it is necessary to sufficiently bind together the hydrated TVP pieces so that patties can be made on high-speed machinery. However, it is also essential that the eating quality of the grilled burger still be maintained for widespread consumer acceptance of the burgers, i.e., the burger patty should have a texture similar to what is found in meat hamburgers.

Examples 3, 4, and 5 demonstrate the effectiveness of various binding and thickening agents in binding the hydrated TVP pieces together through patty forming and grilling, while still maintaining eating quality.

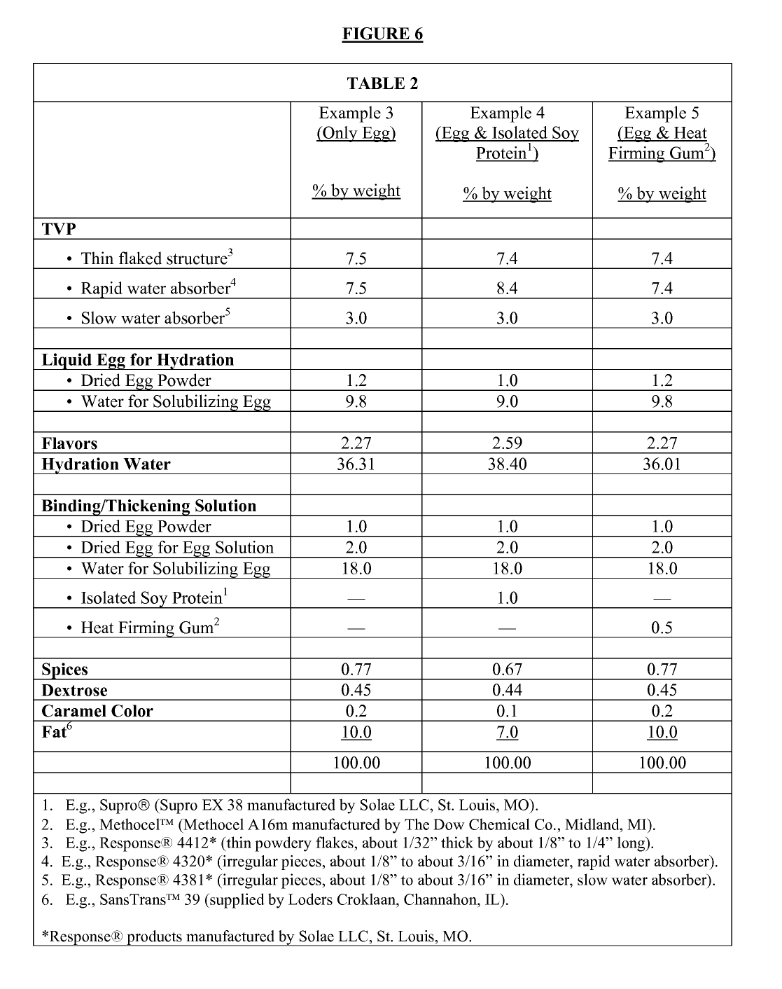

Table 2 in FIG. 6 presents the formulations used to prepare Examples 3, 4, and 5. In all cases, larger quantities of products ranging from 4 kgs to 20 kgs were prepared so that patties could be made on industrial continuously-operating patty forming equipment.

In Example 3, the binding system consisted only of a mixture of liquid egg white solution and dried egg white powder.

Egg white(s) (albumen) are a mixture of heat denaturable soluble proteins which denature (solidify) in a temperature range between 140° F. and 180° F. As such, egg whites are frequently used in various baked foods, meatloafs, souffles, etc., to provide structure to the cooked product. Unfortunately, egg white solutions are low in viscosity and as such are somewhat lacking in binding power when they are not heat denatured.

In Example 4, an insoluble isolated soy protein powder (Supro 38, manufactured by Solae LLC, St. Louis, Mo.) was added to the liquid egg/dried egg mixture to thicken it and provide some viscosity by absorbing water from the liquid egg white solution.

In Example 5, a gum (in this case, Methocel™ A16m, which is a methylcellulose gum manufactured by The Dow Chemical Co., Midland, Mich.) was added to the liquid egg/dry egg mixture to thicken and provide viscosity to the egg solution, by absorbing water from the liquid egg white solution.

There are many vegetable gums (e.g., carrageenan, xanthan, guar, etc.) that are used for thickening. All of these gums form thicker, more viscous solutions at colder temperatures and thinner, less viscous solutions at elevated temperatures. Methocel, on the other hand, is a gum whose solution thickens as the temperature is elevated above 120° F.

Products for Examples 3, 4, and 5 were prepared according to the sequences of FIG. 1, and described in the Detailed Description section.

All products made according to the formulations of Examples 3, 4, and 5 were able to be formed into patties on continuously-operating equipment. On grilling the formed patties, those made according to Examples 3 and 4 easily broke apart, whereas the patties made according to Example 5 maintained their structure reasonably during grilling. However, the binding/thickening formulation used in Example 5 was still not thick enough to prevent the liquid egg white from flowing out of the patty during grilling.

The eating quality (taste, texture in mouth, and lack of soy taste) for products made according to Examples 3, 4, and 5 was good and substantially better than other commercially available plant-based burgers.

### Examples 6, 7, and 8

Examples 3, 4, and 5 demonstrated that it was possible to manufacture plant-based burgers of substantially improved eating quality.

However, patty integrity during grilling was still not optimum. This presents a major problem for widespread distribution of these burgers in chain restaurants. In chain restaurants, product uniformity and speed of preparation is very important and, as such, the maintenance of patty integrity during grilling is critical. Further, depending on the type of sandwich a restaurant desires to sell, different patties are required, most frequently ranging in weight from a ¼ lb patty to a ⅛ to 1/10 lb patty.

Patty size presents an additional problem to patty integrity during grilling, and actually it is more difficult to prevent the smaller patties from breaking during grilling than the larger ones. This applies both to meat hamburgers and plant-based burgers, and is due to reduced binding capabilities in the smaller patties.

It has been discovered that two major formulation changes are required in order to produce plant-based burgers that could be manufactured at high speed, be grilled without partly disintegrating, and which would supply superior eating quality.

First, a more concentrated egg white solution was made by reconstituting egg white powder in a lower quantity of water. It was discovered that a more concentrated egg solution could be made using as little as one part egg white powder to five parts water (as compared to normal liquid egg white which is one part white solids to nine parts water). Thus, the lower quantity of water needed for reconstitution of the egg white powder resulted in substantial improvements in thickening and binding.

Then, a combination of a gum (e.g., Methocel™) and isolated soy protein was added to the concentrated egg white solution to produce an even thicker viscous binding solution so as to more easily hold the hydrated TVP pieces together during patty forming.

Since the more concentrated binding solution now contained two components (egg white protein and methocel), both of which solidified at grilling temperatures, the patties were able to maintain their structure through the grilling process yet be sufficiently friable to easily disintegrate during mastication.

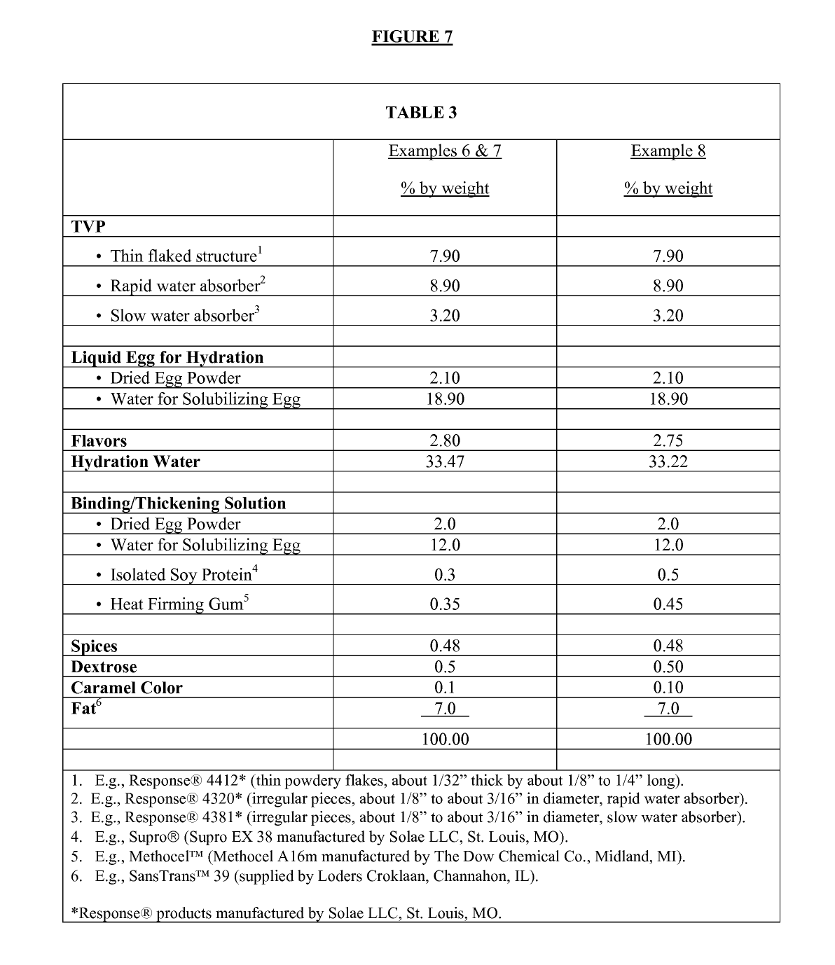

Table 3 in FIG. 7 presents the formulations used in making products representing Examples 6, 7, and 8. In all cases, larger quantities of products ranging from 4 kg to 40 kgs were prepared so that patties could be made on industrial continuously-operating patty-forming equipment. Examples 6 and 8 were made according to the sequences in FIG. 1 and described in the Detailed Description section.

Example 6 was formed into ¼ lb patties (⅜″ in thickness), and Example 8 was formed into ⅛ lb patties (¼″ in thickness).

Example 7, however, used the exact same formulation as Example 6, but was prepared according to the traditional manufacturing procedures. Thus, all the dry ingredients (except fat) together with water were placed in a mixer and mixed for about 40 minutes until all the liquid had been absorbed. The fat was then added and mixed with the other ingredients for an additional two to three minutes, after which the entire mass was cooled with dry ice (solid CO₂) to a temperature of 28° F.

The patties from Example 7 were also formed into ¼ lb patties (⅜″ in thickness).

Products from all three Examples (6, 7, and 8) could be formed on continuously-operating patty-forming equipment.

The patties made according to Example 6 required about 8 minutes to be grilled and maintained their integrity during grilling. The patties made according to Example 7 equally required about 8 minutes to be grilled, but were much more delicate during grilling and frequently broke apart during grilling.

Finally, the patties made according to Example 8 only required 5 minutes to be grilled (due to the fact that the patties were ¼″ thick) and maintained their integrity during grilling.

Clearly, proper water control—both according to the procedure described in FIG. 1 and through the use of more concentrated binding solutions—is essential for the successful manufacture and preparation of burgers.

Burgers made according to Examples 6 and 8 were considered by consumers to be as acceptable as meat hamburgers. Further, these burgers were healthier to consume than regular meat hamburgers since they provided substantially similar quantities of protein, but with about ⅓ to ½ the amount of fat.

Due to factors such as the concentration, heat affected binders/thickeners used in these examples, etc., the egg white solution did not flow out of the patties during grilling. This accentuated the charred colorations of the variable patty surface, making the grilled burger look very similar to a grilled meat hamburger.

A mixture of flavor stabilized TVP particles containing at least 50%, and preferably 60%, irregular sized pieces of around ⅛ inch to 3/16 inch in diameter, some of which absorbed water more slowly than others, together with fine flaked TVP which filled the interstices between the irregular larger-sized TVP particles, was needed to simulate both the textural variety and the surface look of a meat hamburger. The interstices were additionally filled with binder(s).

A concentrated water-based binding/thickening solution containing heat denaturable proteins, gums, and other thickeners provided both textural strength for manufacturing and grilling and friability during mastication. This binding solution also gave the plant-based burger added juiciness so that only 7% to 10% fat was needed in the formulation, thereby producing a healthier alternative to the meat hamburger.

By modifying the composition of the binders and thickeners (see, e.g., formulation of Examples 6 and 8), it was possible to increase the structural strength of the smaller ¼ inch patty (Example 8) so that it maintained its integrity during grilling, and yet remained acceptable for eating enjoyment.

### Examples 9, 10, 11, and 12

Examples 9 and 10 (for burgers), as well as Examples 11 and 12 (for meatballs), were undertaken to demonstrate methods for reducing the saturated fat levels in plant-based burgers and meatballs. Additionally, these examples show the advantages and simplification resulting from the use of liquid molten fat-oil mixtures in the manufacture of plant-based products.

Industrial manufacture of various casing-less plant-based products, such as patties and meatballs, requires a formable mass to be sufficiently cohesive and firm that the ultimate product shape can be formed on high-speed machinery. Clearly, a more liquidy mass is difficult to form, especially at high speeds. Consequently, fats, such as palm fat, that are solid at room temperature, have been used in the manufacture of such plant-based products. Unfortunately, these fats are also high in saturated-fat content and, as such, run counter to nutritionist recommendations that consumers reduce their saturated fat consumption.

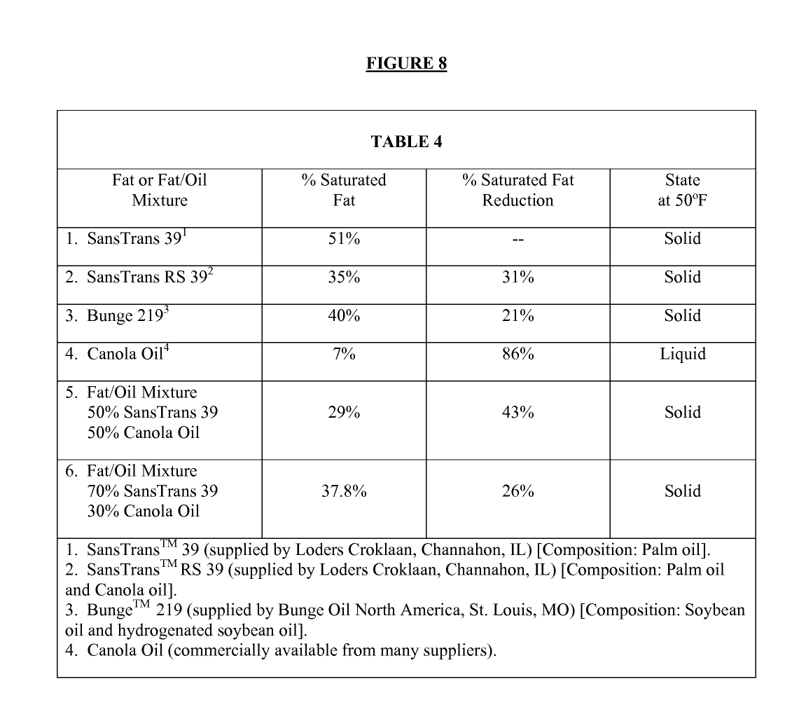

Table 4 in FIG. 8 lists the saturated fat content of six (6) alternative fats and fat-oil mixtures. Palm fat (e.g., SansTrans™ 39), the vegetable fat most frequently used in the industry, contains about 51% saturated fat. However, the saturated fat levels of various alternatives can be substantially reduced by melting a solid fat—which is generally high in saturated fat content—and diluting it with (one or more) low-saturated content liquid oils, such as, e.g., canola oil, corn oil, peanut oil, etc.

Surprisingly, it has been discovered that saturated fat reductions of greater than 40% can be achieved, where the resultant fat-oil mixture will still solidify at temperatures of about 50° F. or less, so that a firm formable plant-protein derived mass can be produced, provided that the mass is chilled to a temperature of between about 27° F. and about 29° F.

Table 5 in FIG. 9 presents formulations used to prepare burger samples (Examples 9 and 10) in the laboratory. It is noted that, as a control, in Example 9, a 1½ lb. batch of burgers, each having a raw weight of 90 grams, was prepared according to the procedure shown in FIG. 1 and described hereinabove. Small solid fat particles of SansTrans™ 39 were used in preparing the product in Example 9. After the addition of solid fat, the mixture was placed in a refrigerator to cool the mix to about 45° F. prior to manually forming patties. These patties were then cooked for 8 minutes in a convection/broil oven set at 400° F., after which the cooked patties were refrigerated for subsequent taste testing.

In Example 10, a 1½ lb. batch of burgers, each also having a 90 gm raw weight, was made according to the procedure shown in FIG. 2 and described hereinabove. In this case, molten liquid SansTrans™ RS 39 (which is a commercially available mixture of approximately 64% SansTrans™ 39 and 36% canola oil) at a temperature of about 110° F. was manually mixed with the plant-protein (see Step 7 of FIG. 2) and the combined mixtures was cooled to about 45° F. by placing it in a refrigerator for about an hour. Patties could be easily hand formed from this refrigerated mass and the patties were sufficiently cohesive and rigid that they could be moved onto trays for subsequent cooking for 8 minutes in a convection/broil oven set at 400° F.

Cooked patties made according the formulations of Examples 9 and 10 were reheated on a griddle set at 360° F. and taste tested. Both products were very similar in taste, texture, and meaty notes. However, the control patties of Example 9 were slightly drier due to the fact that it was easier to render molten fat from the patties made with solid fat particles than from the patties in which the liquid fat was very uniformly distributed during preparation (Example 10). Patties made according to Example 10 contained 2.45 gm saturated fat/100 gm product, which represented a 47% reduction from the saturated fat content of the control patties of Example 9.

Table 6 of FIG. 10 shows formulations used to prepare meatball samples (Examples 11 and 12) to demonstrate that lower saturated fat liquid fat/oil mixtures can also be used in meatball preparation, together with the procedure of grinding the final cooled mass prior to cooking (as discussed previously in connection with FIG. 3, and discussed hereinafter in greater detail in connection with Examples 13, 14, and 15).

1½ lb. batch samples of Examples 11 and 12 were prepared in the laboratory using similar procedures shown and previously described in connection with FIG. 3. The only difference between Examples 11 and 12 was that the product of Example 11 was made using a molten liquid lipid mixture of 50% SansTrans™ 39 and 50% canola oil, whereas the product of Example 12 used a molten liquid mixture of 70% SansTrans™ 39 and 30% canola oil.

In both Examples 11 and 12, the formable mass—after addition of the liquid fat/oil mixture, cooling in a refrigerator to about 45° F., and grinding—could easily be formed manually into meatballs of approximately 1 to 1¼ inches in diameter. After cooking the meatballs at 475° F. for 8 minutes in a convection oven, they were refrigerated for subsequent taste testing.

The meatballs were reheated in a microwave oven for tasting. Both had good smooth texture and meat taste. However, the meatballs made with 50% SansTrans™ 39 and 50% canola oil mix were very soft in bite when compared to the meatballs made with 70% SansTrans™ 39 and 30% canola oil mix. Moreover, the meatballs made according to Example 11 contained 2.2 grams of saturated fat/100 g product. The meatballs made according to Example 12, on the other hand, contained 2.9 grams of saturated fat/100 g product. In both cases, the saturated fat levels were much lower than they would have been if the only fat source had been from SansTrans™ 39 (3.8 g saturated fat/100 g product).

Finally, an alternative method for adding liquid fat or oil was attempted by repeating Example 9 under laboratory conditions according to the procedure shown in FIG. 1, except that, in this case, liquid canola oil was substituted for one half (i.e., 4.5% of the Example 9 formula) of the solid SansTrans™ 39. This liquid canola oil was added to, and mixed with, the aqueous hydration solution prior to hydrating the plant proteins. Despite mixing the canola oil with the hydration solution containing flavors and a heat denaturable soluble protein (albumen or egg white) which is a well-known emulsifier, it was not possible to form a stable emulsion, and the oil-water phase separated within about 60 seconds. Evidently, the salts and acids (lower pH) present in the flavors destabilized any potential emulsions, as is well known from emulsion chemistry theory.

Nevertheless, after rapidly mixing the canola oil with the aqueous hydration solution, this oil-aqueous hydration solution was added to the dry plant proteins, and the combined mixture was mixed for approximately 40 minutes, until there was no observable liquid remaining. The hydrated plant proteins appeared moist, but were oily to the touch. Apparently, the water phase of the hydration solution was completely absorbed and the canola oil was instead distributed over and coated the exterior surfaces of the hydrated plant proteins.

In contrast with Example 9, here, it was found that, after adding the spices, binding solution, and remaining fat as particulate SansTrans™ 39, the resultant formable mass remained quite liquidy. Thus, cooling the mass to 45° F. was insufficient to firm it up for manually forming patties. Consequently, it was necessary to further cool the formable mass to 27° F. by dry ice so as to firm it up sufficiently for manual forming, although the formed patty surfaces still appeared moist (even at the lower temperature).

The formed patties were cooked in a convection/broil oven set at 400° F. for a total of 8¾ minutes. As was customary, the patties were turned over after being in the oven for 5 minutes. Prior to flipping, the burgers had a slight upward bulge in their center, indicating higher water vapor evolution from their underside. Upon turning over the burgers, the reason for the upward bulge in their center became clear—the center underarea of the burgers was covered with an unattractive cream/brown colored layer of (apparently) congealed egg white solution, which was evolving steam and producing the upward bulge. Evidently, the oil covering the hydrated plant protein particles reduced somewhat the ability of the binding solution to attach to, and hold, the various hydrated plant protein particles together. As a consequence, the binding solution was able to more freely flow downward, through the patty to its lower surface where it rapidly congealed. Upon completion of the cooking step, the product was frozen for subsequent taste testing.

The above product was reheated and compared to the reheated commercially available product made according to the procedure of FIG. 1 and the formula of Example 9. The commercial product had a better texture (more crumbly and breaks easily) compared to the above-described experimental product, which had a more spongy texture and an unattractive cream/brown layer on one of its sides.

It should be noted that even if the oil and aqueous hydration could have formed a stable emulsion, this emulsion would have probably caused additional textural problems due to the fact that a large, but well-defined, quantity of the heat denaturable protein emulsifier (i.e., albumen or egg white) would have been needed to be adsorbed onto the surface of the large number of oil particles to stabilize the emulsion. As such, the amount of heat denaturable proteins available for “locking” flavors within the hydrated plant proteins would be reduced by substantial amounts.

Clearly, the use of molten liquid fat or fat-oil mixtures added after the hydrated plant proteins, spices, and binding solution have been mixed is a simple, yet effective, methodology to add fat or reduce saturated fat levels in plant-based products while still permitting ease of formation for different shaped casing-less products. Depending on the fat-to-oil ratio, it is also possible to adjust the softness or firmness of the final cooked product.

### Examples 13, 14, and 15

Examples 13-15 were designed to show ways to make finer, less particulate, and less crumbly textures as are required in meatballs, sausages, and hot dogs.

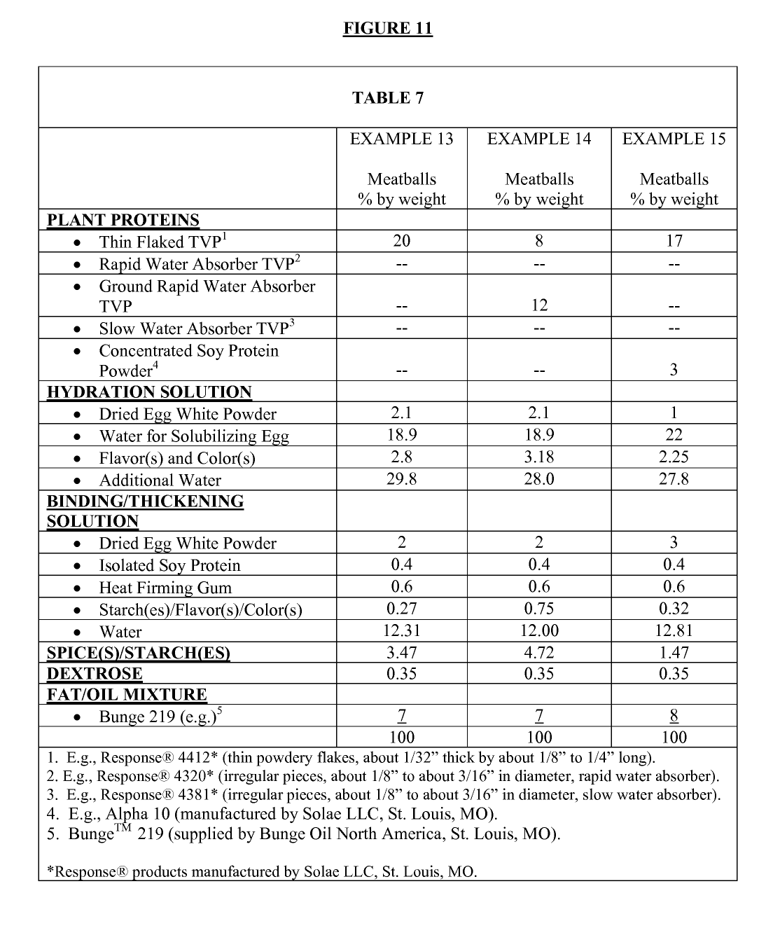

All three 1½ lb. samples (for Examples, 13, 14, and 15, respectively) were made in the laboratory. See Table 7 of FIG. 11. Example 13 was produced according to the procedure of FIG. 2. Only small flaked TVP was used in Example 13 in an attempt to make a less particulate and crumbly product. It was discovered that it was quite difficult to form 1 to 1¼ inch meatballs even after additional cooling in the refrigerator, since the planar flakes could not easily be formed into a cohesive spherical shape. After cooking (at 400° F. for 7½ minutes in a convection/broil oven) meatballs made according to Example 13 were found to be very crumbly and slightly dry in taste tests.

In light of the results from Example 13, Example 14 was carried out with a lower percentage of flaked TVP and pre-ground (using a coffee grinder) rapid water absorbing particulate TVP. In addition, the final mass, including the added molten liquid Bunge™ 219 fat was ground through a meat grinder plate with ⅛ inch holes, in accordance with the procedure set forth in FIG. 3. In this case, it was easy to form 1 to 1¼ inch meatballs, since the final grinding step produced a smooth, easily malleable mass.

After cooking (at 425° F. for 7½ minutes in a convection oven) the meatballs on taste testing were found to be much smoother and firmer in texture (i.e., very little crumbliness), but had some small gritty pieces dispersed within the meatballs. The meatballs were also drier in taste. Evidently, pre-grinding the particulate TVP produces small fine particles that, even when hydrated, are not further degraded by the final grinding step (see Step 8 of FIG. 3).

Based on the results of Examples 13 and 14, Example 15 was carried out with only flaked TVP and a small amount of powdered soy protein powder to enhance the smooth texture of the product. Example 15 was carried out in accordance with the procedure set forth in FIG. 3, using molten liquid Bunge™ 219 fat, and final grinding of the mass through a meat grinder plate with ⅛ inch holes.

Once again, it was very easy to form 1 to 1¼ inch meatballs. The meatballs of Example 15 were taste tested after being cooked in a convective oven at 475° F. for 8 minutes. Surprisingly, the meatballs were found to have a smooth, firmer, non-crumbly texture with no grittiness and good meat flavors.

Grinding of pre-hydrated textured and non-textured plant proteins that have not been pre-ground is clearly important in producing smooth, firmer, non-crumbly textures for products such as meatballs and sausages. Although a fat or fat-oil mixture in molten liquid form is not required in order to produce the smooth-textured products described in accordance with embodiments of the present invention, adding such a fat or fat-oil mixture in molten liquid form may enhance the cohesiveness and/or smooth texture of the product, and allows for manufacture of products containing lower amounts of saturated fat.

In connection with the preceding illustrative examples, it is noted that most products (e.g., those of Examples 9 through 15) made under laboratory conditions are sufficiently firm at temperatures of around 45° F. to be formed manually and moved carefully from being formed to cooking. However, industrial forming of these products at high speed requires further cooling of the formable mass to temperatures of about 27° F. to about 29° F. (depending on formulation) so as to additionally firm up the formable mass and allow the formed products to maintain their shapes throughout the harsher operating conditions of industrial production. It is also noted that, under certain circumstances, the formable mass may be first ground, and then cooled.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, and all changes which come within the meaning and range of equivalency of the claims are therefore intended to be embraced therein.

What is claimed is:

1. A method of producing a plant-based food product, the method comprising:
(a) hydrating dry plant protein particles with a water solution of one or more flavors and one or more heat denaturable soluble proteins to obtain hydrated plant protein particles;
(b) adding a binding and thickening water solution to the hydrated plant protein particles so as to create a formable mass;
(c) adding fat material to the formable mass; and
(d) after the addition of fat, forming the formable mass or one or more portions thereof into said food product.

2. The method of claim 1, wherein said dry plant protein particles are texturized.

3. The method of claim 2, wherein the dry texturized plant protein particles include particles of at least two different sizes.

4. The method of claim 2, wherein the dry texturized plant protein particles include particles of different shapes.

5. The method of claim 2, wherein the dry texturized plant protein particles include particles of different water-absorption speeds.

6. The method of claim 1, wherein said dry plant protein particles are non-texturized.

7. The method of claim 1, wherein said dry plant protein particles comprise texturized and non-texturized particles.

8. The method of claim 7, wherein the dry texturized plant protein particles include one or more of particles having at least two different sizes, particles having different shapes, and particles having different water-absorption speeds.

9. The method of claim 1, wherein said water solution in step (a) further includes one or more food colors.

10. The method of claim 1, wherein the water solution in step (a) is of a quantity that is optimized based on the quantity of the one or more heat denaturable soluble proteins.

11. The method of claim 1, wherein, prior to step (a), one or more flavors and one or more heat denaturable soluble proteins are dissolved in a predefined quantity of water to produce said water solution of one or more flavors and one or more heat denaturable soluble proteins.

12. The method of claim 1, wherein the heat denaturable soluble protein is albumen.

13. The method of claim 1, wherein the binding and thickening water solution includes at least one member selected from the group consisting of a heat denaturable soluble protein, a gum, an insoluble food protein, and a starch.

14. The method of claim 13, wherein the binding and thickening water solution further includes food color.

15. The method of claim 1, wherein each of the one or more heat denaturable soluble proteins is of a type that denatures and solidifies in a temperature range from about 120° F. to about 180° F.

16. The method of claim 1, wherein the one or more heat denaturable soluble proteins are selected from the group consisting of liquid egg white, whey protein, and fractionated soy protein.

17. The method of claim 1, wherein one or more spices are added to the formable mass prior to step (c).

18. The method of claim 1, wherein at least one of dextrose and caramel color is added to the formable mass prior to step (c).

19. The method of claim 1, wherein said fat material is first melted into liquid fat prior to addition to the formable mass.

20. The method of claim 19, wherein said fat material is a mixture of fat and liquid oil.

21. The method of claim 20, wherein the liquid fat has a temperature of about 100° F. to about 120° F.

22. The method of claim 1, wherein said fat material is a mixture of fat and liquid oil that solidifies at a temperature greater than about 40-50° F.

23. The method of claim 22, wherein said liquid oil is vegetable oil.

24. The method of claim 22, wherein said liquid oil is at least one of canola oil, palm oil, and peanut oil.

25. The method of claim 1, wherein, between steps (c) and (d), the formable mass is cooled to a temperature of between about 27° F. and about 29° F.

26. The method of claim 25, wherein, in step (d), the formable mass is formed into a patty.

27. The method of claim 1, wherein said food product is a patty-shaped food product.

28. The method of claim 1, wherein said food product is produced using continuously-operating equipment.

29. The method of claim 1, wherein said food product is a casing-less food product.

30. The method of claim 29, wherein said food product is one of a hamburger and a breakfast sausage patty.

31. The method of claim 1, wherein said food product is configured to be stuffed into a casing.

32. The method of claim 31, wherein said food product is one of a sausage and a hot dog.

33. The method of claim 1, further including grinding the formable mass after step (c), and before step (d).

34. The method of claim 33, wherein, prior to grinding, the formable mass is cooled to a temperature of between about 27° F. and about 29° F.

35. A method of producing a plant-based food product, the method comprising:
(a) hydrating dry plant protein particles with a water solution of one or more flavors and one or more heat denaturable soluble proteins to obtain hydrated plant protein particles;
(b) adding a binding and thickening water solution to the hydrated plant protein particles so as to create a formable mass;
(c) grinding the formable mass to produce a ground formable mass; and
(d) forming the ground formable mass or one or more portions thereof into said food product.

36. The method of claim 35, wherein said dry plant protein particles are not pre-ground while dry.

37. The method of claim 35, wherein said dry plant protein particles are not ground prior to step (c).

38. The method of claim 35, further including cooling the formable mass prior to step (c).

39. The method of claim 38, wherein the formable mass is cooled to a temperature of between about 27° F. and about 29° F.

40. The method of claim 38, wherein fat is added to the formable mass prior to cooling thereof.

41. The method of claim 40, wherein no fat is added to the formable mass prior to step (b).

42. The method of claim 40, wherein said fat is a mixture of fat and liquid oil.

43. The method of claim 42, wherein said mixture of fat and liquid oil solidifies at a temperature greater than about 40-50° F.

44. The method of claim 43, wherein said liquid oil is vegetable oil.

45. The method of claim 35, wherein said food product is produced using continuously-operating equipment.

46. The method of claim 35, wherein said food product is a casing-less food product.

47. The method of claim 35, wherein said food product is configured to be stuffed into a casing.

48. The method of claim 47, wherein said food product is one of a sausage and a hot dog.

49. The method of claim 35, wherein said food product is meatballs.

50. The method of claim 35, wherein said dry plant protein particles are texturized.

51. The method of claim 35, wherein said dry plant protein particles are non-texturized.

52. The method of claim 35, wherein said dry plant protein particles comprise texturized and non-texturized particles.

53. The method of claim 52, wherein the dry texturized plant protein particles include one or more of particles having at least two different sizes, particles having different shapes, and particles having different water-absorption speeds.

54. The method of claim 35, wherein said water solution in step (a) further includes one or more food colors.

55. The method of claim 35, wherein the water solution in step (a) is of a quantity that is optimized based on the quantity of the one or more heat denaturable soluble proteins.

56. The method of claim 35, wherein, prior to step (a), one or more flavors and one or more heat denaturable soluble proteins are dissolved in a predefined quantity of water to produce said water solution of one or more flavors and one or more heat denaturable soluble proteins.

57. The method of claim 35, wherein the binding and thickening water solution includes at least one member selected from the group consisting of a heat denaturable soluble protein, a gum, an insoluble food protein, and a starch.

58. The method of claim 35, wherein the binding and thickening water solution includes food color.

59. The method of claim 35, wherein each of the one or more heat denaturable soluble proteins is of a type that denatures and solidifies in a temperature range from about 120° F. to about 180° F.

60. The method of claim 35, wherein the one or more heat denaturable soluble proteins are selected from the group consisting of liquid egg white, whey protein, and fractionated soy protein.

61. The method of claim 1, wherein one or more spices are added to the formable mass prior to step (c).

62. The method of claim 1, wherein at least one of dextrose and caramel color is added to the formable mass prior to step (c).
